(19) United States
(12) Patent Application Publication
(10) Pub. No.: US 2015/0094623 A1
(43) Pub. Date: Apr. 2, 2015

(54) DEEP VEIN THROMBOSIS ASSEMBLY AND METHOD OF USE

(71) Applicants: Jason M. Howell, Des Plaines, IL (US); Troy A. Mohr, Glenwood, IA (US)

(72) Inventors: Jason M. Howell, Des Plaines, IL (US); Troy A. Mohr, Glenwood, IA (US)

(21) Appl. No.: 14/362,763

(22) PCT Filed: Dec. 6, 2012
(86) PCT No.: PCT/US12/68252

§ 371 Date: Jun. 4, 2014

Related U.S. Application Data
(60) Provisional application No. 61/567,856, filed on Dec. 7, 2011.

(51) Int. Cl. A61G 7/057; A61H 1/00; A61H 9/00

(52) U.S. Cl. CPC A61G 7/05769; A61H 9/0078; A61H 1/008; A61H 9/005; A61G 2007/0513
USPC 601/18; 601/151

(57) ABSTRACT

A system is presented which includes a pressure redistribution mattress which includes a Deep Vein Thrombosis (“DVT”) system positioned therein. The pressure redistribution system contains a plurality of air chambers which are independently controllable. In addition the mattress articulates. The mattress also has a cavity in which a DVT system is housed. This system provides the advantage of combating the potential for bed sores while also providing a DVT system in a convenient location for the patient and medical staff.

### CROSS REFERENCE TO RELATED APPLICATION

This application claims the benefit of U.S. Provisional Application No. 61/567,856 filed Dec. 7, 2012.

### BACKGROUND OF THE INVENTION

This invention is directed toward a mattress having a pressure redistribution system with articulating portions and a plurality of air or foam chambers which are independently controllable. The mattress also has a temperature control system and DVT device.

When a patient is not ambulatory due to illness, injury or surgery, the patient faces an elevated risk of developing additional or piggy-back ailments. A plurality of medical devices has been developed to address some of these ailments.

Deep Vein Thrombosis (“DVT”) is an affliction that causes blood clots particularly in the lower extremities of the legs. When a patient is not ambulatory, the patient faces an elevated risk factor of creating a blood clot. These blood clots, which often accumulate or reside in the patient's calf or thigh, are not, in and of themselves, overly dangerous. However when the blood clot breaks loose they create a pulmonary embolism which can get lodged in the patients heart, brain or lungs where it can cause significant damage or death. It is estimated that in each year 2 to 2.5 million Americans are afflicted by DVT causing 600,000 patients to seek medical care with 300,000 patients succumbing to the effects of the pulmonary embolism. A plurality of devices have been developed to treat or prevent DVT, demonstrative examples of these devices include the Triple Play VT® from Compression Solutions, and VascuTherm by ThermoTek.

Another application faced by non-ambulatory nature of the patient is bed sores or pressure sores which are injuries to skin and underlying tissues that result from prolonged pressure on the skin. Bed sores most often develop on skin that covers bony areas of the body, such as the heel, ankles, hips or buttocks. Patients most at risk of bed sores are those with a medical condition that limits their ability to change positions, or confines them to a bed for prolonged periods. Bed sores can develop quickly and are often difficult to treat due to the non-ambulatory nature of the patient. A plurality of devices have been developed to treat or prevent bed sores including active articulating mattresses and active pressure redistribution mattresses (hereinafter “pressure redistribution mattress”) which help to shift a patient's weight and vary the pressure exerted on portions of the patient's body.

While pressure redistribution mattresses and DVT devices help prevent bed sores and DVT to non-ambulatory patients, problems still remain in the art. Namely, to treat or prevent both bed sores as well as DVT currently two individual devices must be purchased, installed and used. That is, an active or reactive pressure redistribution mattress must be purchased and installed as well as a DVT device. An active pressure redistribution system involves actively adjusting pressure in various chambers of the mattress, such as actively pumping-in or sucking-out air from separated sections of a mattress so as to vary the pressure on these portions of a patient's body; whereas a reactive pressure redistribution system involves various cambers of the mattress which react or adjust to the moving body weight of the patient. An active redistribution system and a DVT system each have their own power cords which must be plugged-in. This causes excess cluttering in the patient's room, can cause an unsafe work environment and can cause injury to the patient in the event that a cord is tripped over. In addition, locating, installing, using and adjusting these two individual devices causes extra work, time and money. This is especially true when considering that often times patients requiring DVT prevention also require bedsore prevention, and vice versa. Also, considering that DVT devices and redistribution mattresses share many of the same components, such as pumps, wiring, tubing, controllers and power sources, excess costs are incurred by having to purchase duplicates of these components.

Thus, it is a primary objective of the present invention to provide a single device that treats or prevents DVT and bed sores.

Another objective of the present invention is to provide a device that reduces the cost of treating DVT and bed sores.

Yet another objective of the present invention is to provide a device that improves the safety of treating DVT and bed sores.

Another objective of the present invention is to provide a device that improves the ease at which DVT and bed sores can be treated.

These and other objects, features, or advantages of the present invention are apparent to one of skill in the art from the specification, drawings and claims.

### BRIEF DESCRIPTION OF THE DRAWINGS

FIG. 1 is a perspective view of a DVT and active pressure redistribution mattress.

FIG. 2 is a plan view of a DVT and active pressure redistribution mattress.

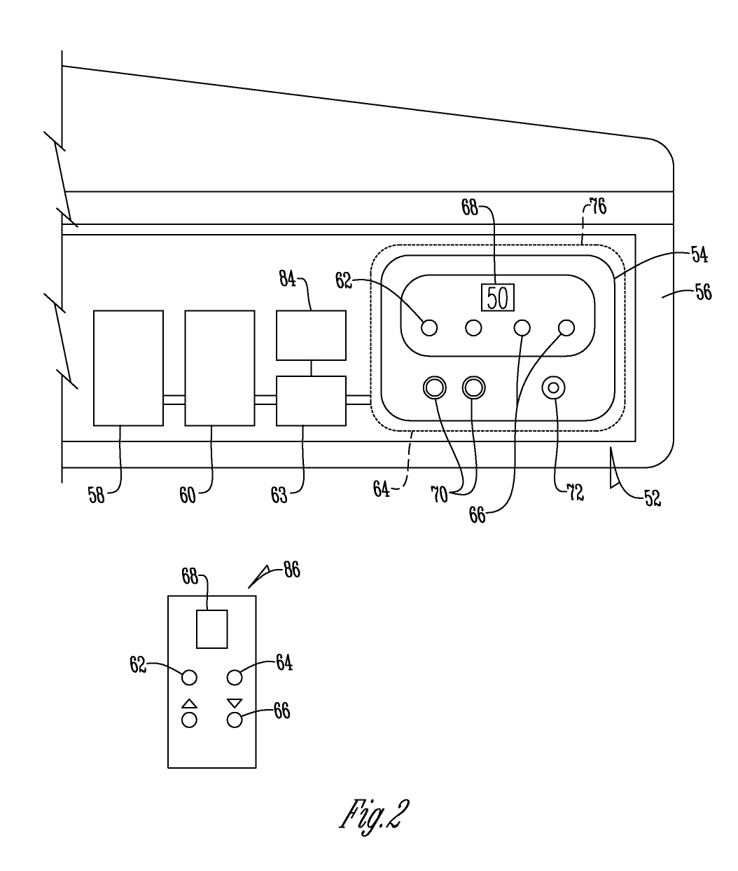

FIG. 3 is a plan view of a DVT and active pressure redistribution mattress.

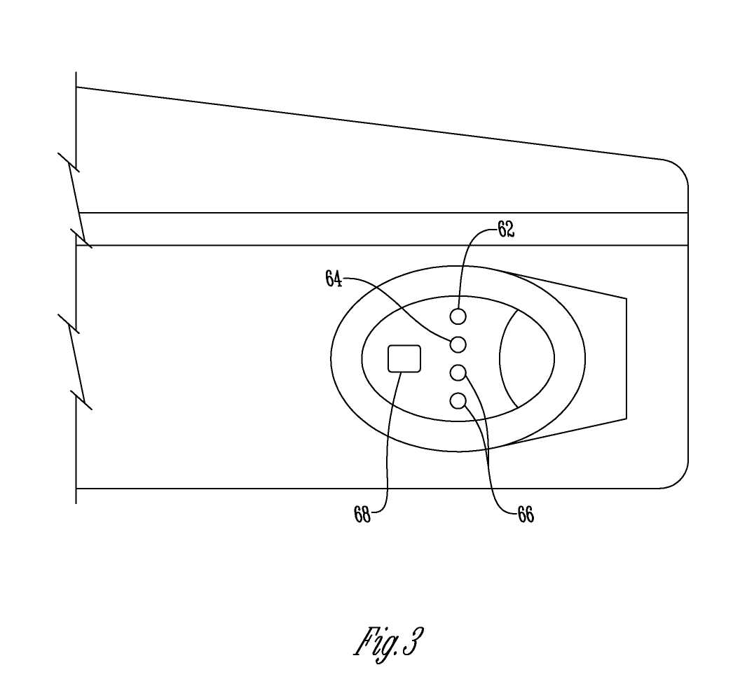

FIG. 4 is a perspective view of a DVT device incorporated into an operating table and an operating table mattress.

FIG. 5 is a perspective view of a DVT device incorporated into the footboard of a hospital bed; and

FIG. 6 is a close up perspective view of a DVT device incorporated into the footboard of a hospital bed.

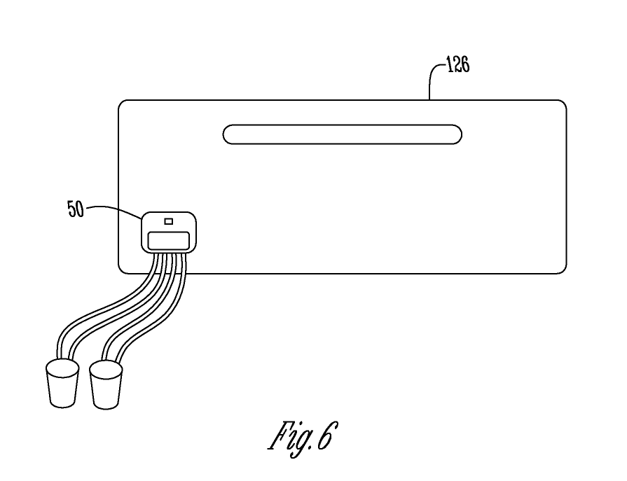

FIG. 7 is a close up perspective view of a DVT device incorporated into a mattress.

### DETAILED DESCRIPTION OF THE INVENTION

Referring to the figures, a combined DVT and Active Pressure Redistribution Mattress 10 is presented. The device 10 has pressure redistribution mattress 12 having a top side 14, a bottom side 16 and opposing head end 18 and foot end 20. Positioned within mattress 12 is a pressure redistribution system 22 which is covered by an outer layer 24, such as cloth or fabric. Alternatively, mattress 12 is simply a standard mattress such as a foam, coil spring, Sleep Number®, Tempur-Pedic® or other conventional mattress as is well known in the art. In one arrangement, mattress 12 is made of a multilayered foam and gel arrangement, wherein the top layer is gel, the middle layer is a medium density foam and the bottom layer is a high density foam. The layers of foam may or may not be memory foam. Additional layers of foam are hereby contemplated which increase in firmness towards the bottom of the mattress.

Pressure redistribution system 22 includes any articulating mattress known in the art. As an example, pressure redistribution system 22 includes a frame system 26 connected to a plurality of joints 28. At least one motor 30 is connected to the frame system 26 which is preferably associated with each joint or set of joints 28 so as to articulate mattress 12. Motor 30 is electrically connected to and controlled by controller 32. Motor(s) 30 and controller 32 are positioned within and/or connected to mattress 12.

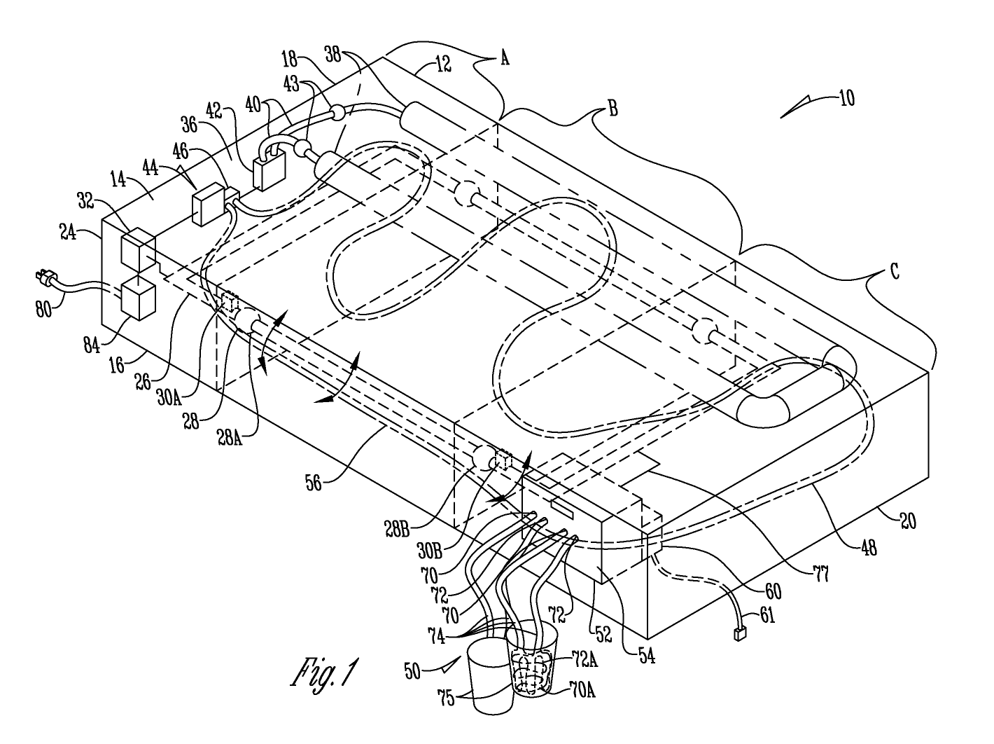

As another example, mattress 12 is broken down into three separate portions, an upper body portion A, a torso portion B and a lower body portion C, approximately along fold-lines presented in dashed lines in FIG. 1. The upper body portion is positioned towards the head end 18 of a first set of joints 28a with a first motor 30a associated therewith. The lower body portion is positioned towards the foot end 20 of a second set of joints 28b with a second motor 30b associated therewith. The torso portion is positioned between the first set of joints 28a and the second set of joints 28b. Alternatively, only a single set of joints 28 and motors 30 are located within the mattress 12 thereby separating the mattress 12 into two separate segments, the head end 18 and foot end 20. When activated by controller 32, each motor 30 effects the angle of joint 28 so as to articulate mattress 12 from a flat position to a fully articulated position, either upwardly or downwardly, or any position therebetween. This angular articulation is represented by the curved arrows presented on FIG. 1.

Pressure redistribution system 22 also includes a plurality of pressure varying devices 36. In one embodiment, pressure varying devices 36 include a plurality of air chambers 38 which are fluidly connected by tube 40 to pump 42. Pump 42 is electrically connected to and controlled by controller 32, which, when activated, increases or decreases the pressure in air chambers 38 by filling or emptying air chambers 38. Air chambers 34 are positioned in parallel relation to one another with a space positioned between each air chamber 34 or alternatively with each air chamber 34 connected to the adjacent air chamber 34. Air chambers 34 extending the length of mattress 12 from the head end 18 to the foot end 20, and from side to side. The air pressure within each individual air chamber 38 is independently controllable through an arrangement of tubes 40 and valves 43 connected to each air chamber 38. Alternatively, the air chambers 38 of mattress 12 are further segmented into upper body portion A, a torso portion B and a lower body portion C so that the pressure of each of these portions can be independently varied despite the pressure of the other portions A, B, C. Further segmentation is hereby contemplates, such as right and left portions within each segment A, B, C, and so on. Alternatively, mattress 12 only has a single air chamber 38.

Mattress 12 also includes a temperature control system 44. Temperature control system 44 is any temperature controlling system known in the art such as an air conditioning unit and/or a heating unit. In one embodiment, temperature control system 44 includes a heat pump 46 connected to a conduit 48 which travels back and forth across mattress 12 just beneath outer layer 24. Heat pump 46 is electrically connected to and controlled by controller 32. When activated, heat pump 46 passes warmed or cooled fluid, gases or liquid through conduit 48 so as to warm or cool mattress 12. Similar to air chambers 38, conduit 48 is separated into a plurality of individually controlled portions or segments, such as an upper body portion A, a torso portion B and a lower body portion C so that the temperature of each of these portions can be independently varied regardless the temperature of the other segments. Alternatively, mattress 12 only has a single segment of conduit 48 as is shown. In an alternative arrangement wherein heated and/or cooled air is used, this temperature controlled air is circulated through air chambers 38.

Connected to mattress 12 is a DVT system 50. DVT system 50 has a housing 52 with a user interface 54, which controls all components and functionality of mattress 12. User interface 54 is positioned in flush alignment with the a side surface 56 of mattress 12, such as adjacent the right side, the left side, the head end 18 or foot end 20, so as to allow for easy interaction by a user. The DVT system 50 has a first pump 58 for pumping gasses or air, and a second pump 60 for pumping fluids and/or gases. The second pump 60 is fluidly connected to a heat pump 62 so as to enable the pumping of heated or cooled fluids or gases through the DVT system 50. In another arrangement, second pump 60 is connected to an external source of warm or cool fluids by conduit 61 such as a cooler of ice water, or a conventional faucet connected to a source of warm or cold water. DVT system 50 also has a DVT controller 63 which controls the DVT system 50.

The user interface 54 of the DVT system 50 has a power button 62 which activates and deactivates the DVT system 50. The DVT system 50 has a mode button 64 which allows the user to select the mode of operation of the device, such as cycling, pressure, temperature and time as is well known in the art of DVT devices. The DVT system 50 also has pair of pressure and temperature selectors 66, which allow the user to adjust the temperature or pressure of the DVT system 50 upwardly and downwardly. The DVT system 50 also has a display 68 which displays various information of the DVT system 50 such as mode of operation, pressure, temperature, status, time, etc. The user interface 54 is also connected to controller 32 and also controls the other components and functions of the mattress 12 as is described herein, such as the pressure redistribution system 22 and temperature control system 44. In another arrangement, the controller 32 is incorporated within the DVT system 50.

The DVT system 50 also has at least one, if not two or more pressure connectors 70. Pressure connectors 70 are fluidly connected to first pump 58. DVT system 50 also has at least one temperature connector 72, if not two or more temperature connectors 72. Temperature connectors 72 are fluidly connected to second pump 60 and heat pump 62. Tubes 74 are removably and replaceably connected to connectors 70, 72 at one end and to DVT sleeves 75 at the opposite end. DVT sleeves 75 are any form of DVT sleeve known in the art such as a foot, calf, knee, thigh, hip, shoulder, elbow, arm, hand or any other sleeve which apply pressure to a patient's body so as to prevent DVT condition from occurring. Sleeve 75 has passageways 70A therein which are connected to pressure connectors 70 by tubes 74 which allows for pressurized fluid or gasses to be pumped therethrough so as to prevent DVT condition from occurring. Sleeve 75 also has passageways 72A therein which are connected to temperature connectors 72 by tubes 74 which allows for warmed or cooled fluid or gasses to be pumped therethrough so as to reduce swelling on the wrapped portion of the patient's body so as to manage or reduce swelling or otherwise aid in the healing process.

In another arrangement DVT sleeves 75 include a pocket 75A. Pockets 75 A are any sized and shaped pocket. Removeably and replaceably positioned within pocket 75A is a thermal pack 75B. Thermal packs 75B are any device which can be used to warm or cool the patient's body covered by sleeve 75. In one arrangement, thermal pack 75B is a freezer gel pack or a warming gel pack used to warm or cool the patient's body when it is positioned within pocket 75A.

DVT system 50 is connected to mattress 12 by any means known in the art. As one example DVT system 50 has a flap of material that extends around the exterior edge of user interface 54 which is connected to mattress 12 by any means known in the art such as being sewn by stitching 76, glued, zippered, buttoned, screwed, bolted, Velcroed® or otherwise attached by any other means.

For further support and additional assurance that DVT system 50 is connected to mattress 12, DVT system 50 is connected to frame 26 or the material mattress 12 is made of by a connecting member 77. Connecting member 77 is any device which connects DVT system 50 to mattress 12 or the material of mattress 12 such as a screw, bolt, a zip-tie, an elastic band, a spring, a string, or any other device. DVT system is positioned within a pocket or cavity 78 within the material of mattress 12, as is described in greater detail in the below example.

The mattress 12 has a single power cord 80 connected to an external power source 82 (not shown) such as a conventional wall socket or a socket in operating table or the bed mattress 12 is supported by. Alternatively, or in addition, mattress 12 also has an internal power source 84 such as a battery. These power sources 82, 84 are electrically connected to all power using devices of the system 10.

To provide for easy use and control of the system, including pressure redistribution system 22 and the DVT system 50 a remote 86 is electrically and/or wirelessly connected to the controllers 32, and 63 for the articulation and pressure redistribution system 22, the temperature control system and the DVT system 50. Remote 86 contains similar or identical controls as user interface 54 as is described herein.

In one embodiment, so as to save costs and to reduce duplicative devices within the system 10, the pressure redistribution system 22 and DVT system 50 share components. That is, the pressure redistribution system 22 and DVT system are controlled by the same controller 32/63. The pressure redistribution system 22 and DVT system utilize the same pump 42/58 for pumping gases and air. The pressure redistribution system 22 and DVT system 50 utilize the same heat pump 46 for pumping heated or cooled gases or fluids. The pressure redistribution system 22 and DVT system 50 are controlled by the same user interface 54 and remote 86. In addition, the pressure redistribution system 22 and DVT system share as many systems as possible so as to reduce redundancy as well as costs. To control the system, DVT system 50 has software embedded in controller 32/63 which manages all systems of the device 10.

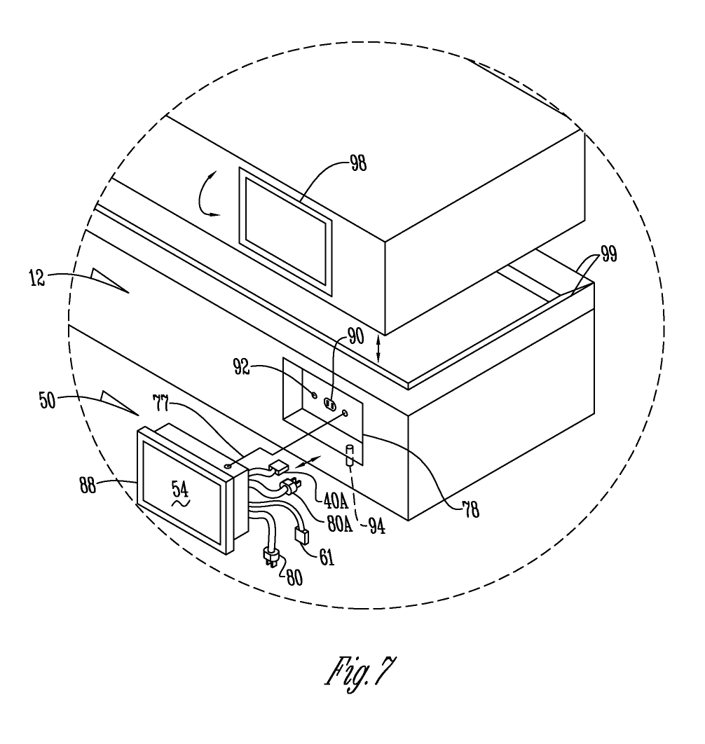

As one example, with reference to FIG. 7, cavity 78 is positioned within the material mattress 12 is made of. Cavity 78 is sized and shaped to receive the body of DVT system 50. That is, cavity 78 receives DVT system within close tolerances so that the DVT system 50 fits within cavity 78 with frictional engagement, thereby helping to hold DVT system 50 within cavity 78. To provide additional frictional engagement, the exterior surface of DVT system 50 has a roughened, ribbed or flanged surface or includes frictional members such as Velcro to increase the connection between the DVT system 50 and cavity 78.

To provide further assurance that DVT system, 50 is connected to mattress 12 and does not fall out, a connecting member 77 is connected to mattress 12 and DVT system 50. In the arrangement shown in this example, connecting member 77 is a zip-tie, an elastic band, a spring, a string, or any other device connected to the interior of cavity 78 and to the body of DVT system 50. More specifically, connecting member 77 is connected to the back of cavity 78 and the back or body of DVT system 50 and is tightened therebetween as the DVT system 50 is installed in mattress 12.

When installed in mattress 12, a layer of mattress material is positioned on all sides of DVT system 50. That is, there is a layer of mattress material between the top side the back side, the right side, the left side and the bottom side of the DVT system 50. This layer of mattress material protects the patient using the mattress 12 from feeling the DVT system 50 within the mattress.

Extending around the exposed face or user interface 54 of the DVT system 50 is a flange 88. Flange 88 engages the side surface 56 of mattress 12 and prevents DVT system 50 from being inserted too far into mattress 12. Flange 88 is also connected to the material of mattress 12 by any means known in the art such as stitching, gluing, welding, Velcroing® or the like.

In this arrangement, the interior of cavity 78 has an electrical interface 90. Electrical interface 90 is any form of electrical connection such as a plug, or wires to which DVT system is connected to so that DVT system 50 can control the systems of mattress 12. The interior of cavity 78 also has a fluid interface 92. Fluid interface 92 is any form of a gas or fluid connection such as a quick disconnect plug to which DVT system is connected to so that DVT system can pass fluids or gasses through mattress 12 thereby controlling the pressure or temperature of mattress 12 as is described herein, such as the air chambers 38 and or the conduit 48. DVT system 50 has corresponding wires 80A and tubes 40A which connect to electrical interface 90 and fluid interface 92 respectively. The interior of cavity 78 also has a channel 94 that provides a passageway from cavity 78 to the exterior of mattress 12 through which cords and tubes connected to DVT system 50 exit the mattress 12. Conduit 94 is used to pass conduit 61 or power cord 80 out of DVT system, through mattress 12 so as to connect power cord 80 to an external power source or conduit 61 to external source of water or gas.

The system 10 also includes a mattress cover 96. Mattress cover 96 is made of any material which is suitable for its intended purpose. In one arrangement, mattress cover 96 is made of a sanitary and impermeable material such as a vinyl, plastic, composite or similar material which prevents liquids or fluids from penetrating the cover 96. This is particularly useful in operation room uses where there is a high likelihood of being contaminated. In this way, less expensive cover 96 protects the more expensive mattress 12 and can be thrown away and replaced without having to replace the entire mattress 12. Mattress cover 96 has a door 98 therein. Door 96 can be opened and closed and is positioned directly over DVT system 50, such that when door 98 is opened it reveals the user interface 54 of DVT system 50. Door 98 includes a sealing means around its periphery such as magnets, a zipper, buttons, snaps, Velcro® or the like that help to hold door 98 closed when the DVT system is not needed while allowing a user to easily open and close door 98.

Also, as shown in FIG. 7, the system 10 includes a fall-prevention system 99. Fall preventions system 99 includes a defined perimeter or barrier positioned along the sides 56 in one arrangement, and along the sides 56 as well as the foot end 20 and head end 18 in another arrangement, of mattress 12 and extend upwardly therefrom. These raised edges provide a barrier that help to prevent a patient from rolling or falling out of bed and create a low spot in the center of mattress 12. These raised edges take on any shape such as triangular (as is pictured in FIG. 7) as well as square, round, rectangular, or any other shape. In one arrangement, the fall preventions system is formed directly within the mattress 12 and is an integral and non-removable part thereof. In another arrangement, the fall prevention system is removable and is added when-necessary to the mattress 12 under cover 96. Fall prevention system 99 is made of the same material as mattress 12, such as foam, or alternatively, fall prevention system 99 is made of a different material. In one arrangement, fall prevention system is made of a firmer or stiffer material than mattress 12 so as to help keep patient from falling off mattress 12.

Operating Table:

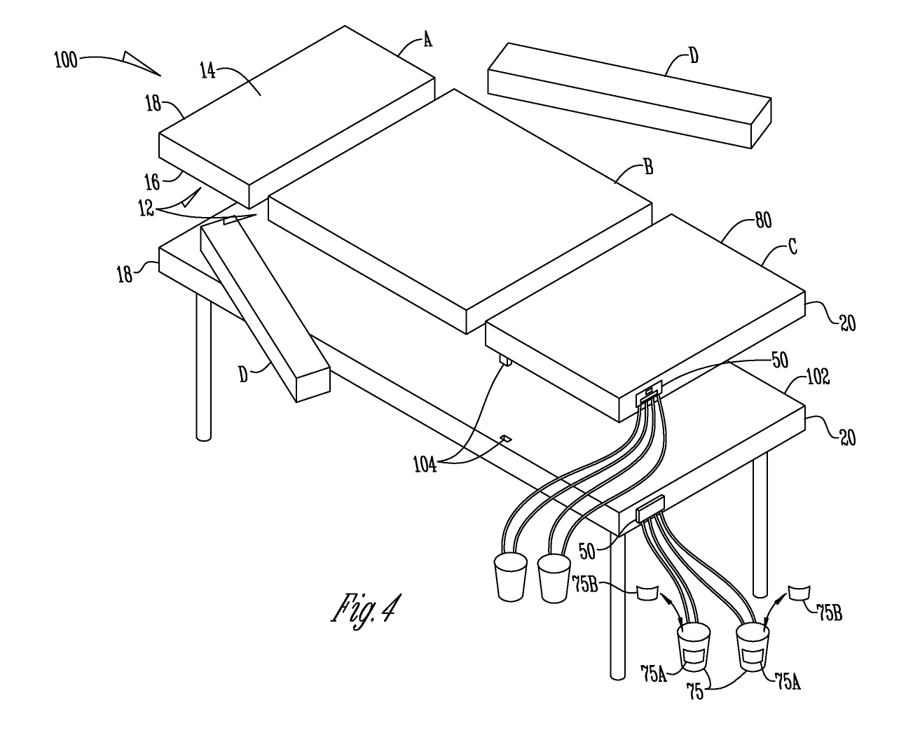

In an alternative arrangement, and in addition to the above disclosure which described a single mattress 12, with reference to FIG. 4, an operating table assembly 100 is presented. Operating table assembly 100 has a conventional operating table 102 as is well known in the art. Conventional operating tables 102 perform a variety of functions to assist in the surgical procedures such as articulating, raising and lowering, separating, etc. Modern operating tables 102 are sophisticated devices which require power and motors to properly adjust and position the patient for optimal surgery results.

Positioned on top of the operating table 102 is a surgical mattress 12. In one embodiment, surgical mattress 12 is separated into portions including upper body portion A, torso portion B, and lower body portion C and arm portions D. More or less portions may be required depending on the particular design and intended use of the operating table 102. In this arrangement, the operating table mattress 12 is separated into particular portions, A, B, C, D so as to allow the operating table to articulate, as well as to reduce the replacement cost in the event that any mattress portion is cut by a scalpel or contaminated through the operating procedure.

Connected to and positioned within any portion of the surgical mattress 12 is a DVT system 50. DVT system 50 is connected to the mattress 12 in the manner described herein. In one arrangement, DVT system 50 is positioned within the foot end 20 of the lower body portion C of the surgical mattress 12. However, the DVT system 50 can be positioned within any portion of the surgical mattress 12. In one arrangement, the DVT system 50 is included in the portion closest to the portion of the patient's body that is being operated on.

The DVT system 50 is connected to a power source either through a power cord 80 to an external power source, to an internal power source 84, or alternatively, surgical mattress is connected through harness 104, to power system of operating table 102. In one arrangement, harness 104 is a shortened conventional electrical plug which is designed to be plugged into the operating table 102. Connecting DVT system 50 to the power system of operating table 102 reduces the number of cords required in an operating room, which improves the working conditions of an operating room and eliminates the dangerous condition of another power cord being stretched to the closest socket. This allows for increased mobility around the patient.

Operating Table Assembly:

Alternatively, instead of being positioned within the mattress 12 of the operating table assembly 100, DVT system 50 is positioned within any portion of the operating table 102 itself. In one arrangement, DVT system 50 is positioned within the foot end 20 of the operating table 102. However, the DVT system 50 can be positioned within any position of the operating table 102. All other functions and arrangements described herein are incorporated into the operating table arrangements, including the manner of operation and the manner of attachment and the like.

Hospital Bed Assembly:

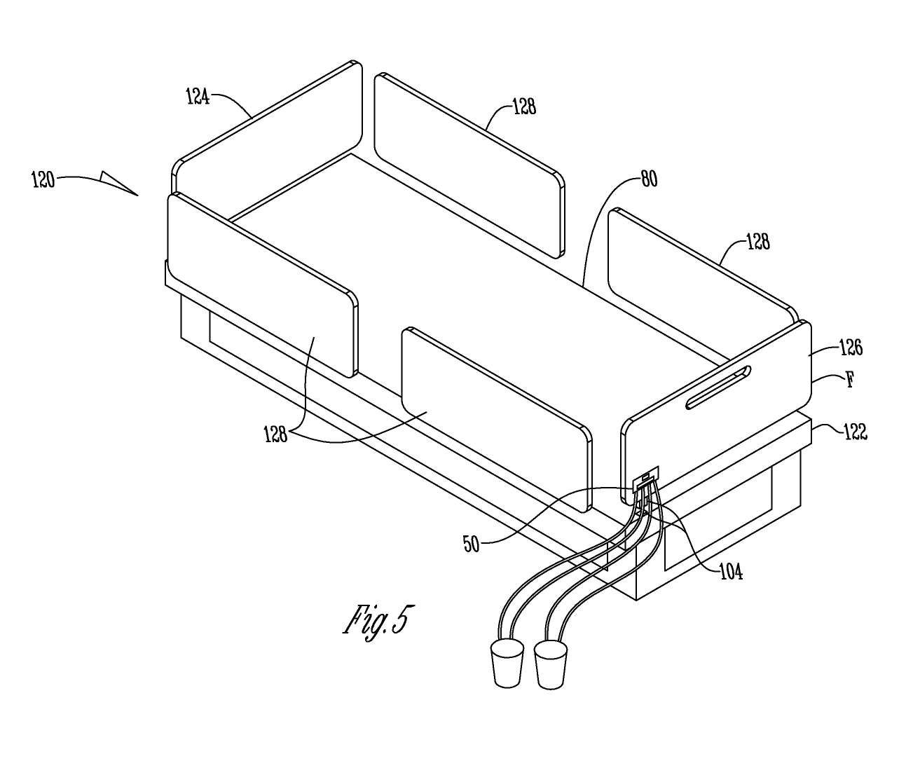

In an alternative arrangement, and in addition to the above disclosure, with reference to FIG. 5, hospital bed assembly 102 is presented. Hospital bed assembly 120 has a hospital bed 122 with removable head board 124, foot board 126, and side panels 128.

Conventional hospital beds 122 perform a variety of functions to assist in in-room procedures and patient recovery such as being articulating, raising and lowering, separating, allowing for the removal of bed pans, etc. Modern hospital beds 122 are sophisticated devices which require power and motors to properly adjust and position the patient.

Connected to and positioned within a removable portion 124, 126, 128 of hospital bed 122 is a DVT system 50. In one arrangement, DVT system is positioned within in and connected to head board 124 or footboard 126. DVT system 50 is connected to the head board 124 or foot board 126 in the manner described herein.

In this arrangement, the DVT system 50 is connected to a power source either through a power cord 80, to an internal power source 84, or alternatively, DVT system 50 is connected through harness 104, to the power system of hospital bed 122. In the arrangement using harness 104, when the foot board 126 is installed on the hospital bed 122, harness 104 in foot board 126 matingly receives harness 104 in the hospital bed 122 thereby powering DVT system 50. Connecting DVT system 50 to the power system of hospital bed 122 reduces the number of cords required in a hospital room, which improves the working conditions of the hospital room and eliminates the dangerous condition of another power cord.

In one arrangement DVT system 50 is a stand alone unit which is merely positioned within an opening or recess of foot board 126. In another arrangement, DVT system 50 is molded within, or is an integral part of foot board 126 and therefore DVT system 50 cannot be separated from foot board 126 without dismantling foot board 126.

In Operation:

In operation, with reference to the mattress arrangement, however the same applies to the operating table arrangement and hospital bed arrangement; a user plugs power cord 80 of mattress 12 into an external power source. Through the user interface 54 or remote 86, a user adjusts the pressure redistribution system 22. That is, the user adjusts the articulation of the various portions of the mattress 12 from a flat alignment to an articulated alignment either upwardly or downwardly. When doing so, controller 32 activates respective motors 30 which then articulates portion of frame 26 at joints 28. In this way, the patient's body position is adjusted angularly.

Next, a user adjusts the air pressure within the air chambers 38 through interface 54 or remote 86. When activated, controller 32 activates pump 42 which pumps air into or sucks air out of air chambers 38 thereby varying the pressure experienced by the patient. Or alternatively, an active pressure redistribution mode is selected which intermittently varies the pressure in t air chambers 34 based on the software program thereby constantly changing the pressure experienced by the patient and thereby reducing the potential for bed sores.

Next, a user adjusts the temperature of mattress 12 through interface 54 or remote 86. When activated, controller 32 activates heat pump 46 which passes heated or cooled fluids or gasses through conduit 48 thereby heating or cooling the patient.

When DVT prevention is needed, a user connects tubes 74 to connectors 70 and/or 72. The user then connects DVT sleeves 75 to the affected portion of the patient's body. In the event that additional warmth or cooling is needed, thermal pack 75A is positioned in pocket 75B. The user then activates the DVT system through the user interface 54 or remote 86. First, the user activates the DVT system 50 by depressing power button 62. Next the user selects the mode through the mode button 64 and then selects the pressure setting or temperature setting through pressure and temperature selectors 66. Once set, the DVT system 50 proceeds to carry out the DVT prevention program by cycling pressurized air and/or heated or cooled fluid through sleeve 75 until it completes the program or cycle or the user or patient deactivates the DVT system 50 or modifies the settings.

Financial Method:

In addition to the improved apparatus and method of use described herein, also presented is an improved financial method of providing and using a mattress 12 having a DVT system 50 therein. In this financial method, the manufacturer of the system 10 (which includes a mattress 12 having a DVT system 50 therein) provides the system 10 to a hospital or end user free of charge. In return, the hospital into an agreement wherein the hospital will purchase a specified number of consumable pieces associated with the system 10 from the manufacturer over a specified timeframe. In one arrangement, the hospital agrees to purchase all consumable parts from manufacturer.

In this arrangement, the hospital has the right to use the system 10, however the hospital does not own the system. However, the hospital must purchase a minimum number of consumable parts such as sleeves 75, tubes 74, covers 96 and the like from manufacturer.

In this method, either the manufacturer or the hospital will carry the service and maintenance costs associated with the durable portions of the system. Alternatively, the hospital and the manufacturer may split the service and maintenance costs associated with the durable portions of the system.

As one example of the financial method in use, the manufacturer agrees to supply 100 systems 10 to a new hospital that is about to open. In return, the hospital executes a 5-year agreement wherein the hospital will purchase all consumable parts associated with the system from the manufacturer. In addition, the hospital agrees to purchase at least three pairs of sleeves 75 from the manufacturer at a specified price per month for each system 10 delivered to the hospital throughout the duration of the 5-year period. At the end of this initial 5-year period the parties are free to renegotiate the agreement.

This arrangement reduces the hospital's upfront costs while allowing the hospital access to the cutting edge technology presented in the system 10. In return, the manufacturer receives a guaranteed steady minimum return on each unit supplied. Accordingly each party receives a substantial benefit.

From the above discussion it will be appreciated that the described DVT System and Active Pressure Redistribution Mattress 10 provides and offers many advantages over the prior art. Namely, the herein described device presents a single device which prevents both DVT and bed sores and unintentional bed falls. The herein described device also reduces the cost of treating DVT and bed sores by providing a single device that shares components, or reduces the use of redundant components. The herein described device also improves the safety and convenience of treating DVT and bed sores by eliminating unnecessary cords and devices. The system also increases access to this technology by providing the system at low upfront costs.

It will be appreciated by those skilled in the art that other various modifications could be made to the device without parting from the spirit and scope of this invention. All such modifications and changes fall within the scope of the claims and are intended to be covered thereby.

What is claimed is:

1. A DVT prevention system comprising: a mattress; said mattress having a cavity positioned therein; a DVT system positioned within the cavity; a DVT sleeve operatively connected to the DVT system and removably positioned around a portion of a patient's body; wherein when activated the DVT system provides pressure to the patient's body thereby preventing DVT.

2. The system of claim 1 wherein the mattress contains an active pressure redistribution system including a plurality of air chambers.

3. The system of claim 1 wherein the mattress articulates.

4. The system of claim 1 wherein the DVT system has a user interface that is positioned adjacent an exterior surface of the mattress.

5. The system of claim 1 wherein the mattress has a defined perimeter fall prevention system positioned along an edge of the mattress.

6. The system of claim 1 wherein the DVT system provides temperature controlled fluids to the DVT sleeve.

7. The system claim 1 further comprising a mattress cover having a door therein that covers and provides access to a user interface of the DVT system.

8. A financial system of providing a DVT mattress system comprising the steps of entering into an agreement between an equipment provider and an end user wherein the equipment provider agrees to provide a mattress having a DVT system therein to the end user, and wherein the end user agrees to purchase consumable parts related to the mattress having a DVT system therein from the equipment provider; providing a mattress having a cavity positioned therein and a DVT system positioned within the cavity by the equipment provider to an end user; purchasing consumable parts related to the mattress having a DVT system therein from the equipment provider by the end user.

9. The method of claim 8 further comprising wherein the end user agrees to purchase a specified number of DVT sleeves from the equipment provider per month.

10. A DVT prevention system comprising: an operating table assembly having a top surface and a side surface; said operating table assembly having a cavity positioned therein;
a DVT system positioned within the cavity; a DVT sleeve operatively connected to the DVT system and removably positioned around a portion of a patient's body; wherein when activated the DVT system provides pressure to the patient's body thereby preventing DVT.

11. A DVT prevention system comprising: a bed having a head board, a foot board and at least one side panel; a cavity positioned in one of the head board, the foot board or the at least one side panel a DVT system positioned within the cavity; a DVT sleeve operatively connected to the DVT system and removably positioned around a portion of a patient's body; wherein when activated the DVT system provides pressure to the patient's body thereby preventing DVT.
